(19) United States
(12) Patent Application Publication
(10) Pub. No.: US 2010/0301808 A1
(43) Pub. Date: Dec. 2, 2010

(54) CHARGING DEVICE AND PORTABLE ELECTRONIC DEVICE EMPLOYING THE SAME

(75) Inventor: DARYLL DAVID, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/576,654

(22) Filed: Oct. 9, 2009

(30) Foreign Application Priority Data
May 27, 2009 (CN) 200910302677.X

(51) Int. Cl. H02J 7/00

(52) U.S. Cl. 320/138; 320/137

(57) ABSTRACT

A charging device for recharging a battery includes an electric energy generating module, a voltage regulating module, and a battery electrically connected. The electric energy generating module converts kinetic energy into electric energy and outputs an unstable voltage. The voltage regulating module stabilizes the unstable voltage into stable voltage. The charging circuit outputs the stable voltage to the battery.

### BACKGROUND

1. Technical Field

The disclosure generally relates to charging devices, particularly to a charging device for a portable electronic device.

2. Description of Related Art

Portable electronic devices, such as mobile phones and personal digital assistants (PDAs), are generally equipped with rechargeable batteries. When electric energy of the battery is low or empty, a power source is required to recharge the battery.

However, when power sources are not available, the portable electronic device may not be conveniently recharged. In addition, the charger is usually a separate component from the portable electronic device.

Therefore, there is room for improvement within the art.

### BRIEF DESCRIPTION OF THE DRAWINGS

Many aspects of a charging device and a portable electronic device employing the same can be better understood with reference to the following drawings. The components in the drawings are not necessarily to scale, the emphasis instead being placed upon clearly illustrating the principles of the present charging device and a portable electronic device employing the same. Moreover, in the drawings, like reference numerals designate corresponding parts throughout the several views.

FIG. 1 is a block diagram of a portable electronic device, according to an exemplary embodiment.

FIG. 2 is a block diagram of a portable electronic device, according to another exemplary embodiment.

### DETAILED DESCRIPTION OF THE EMBODIMENTS

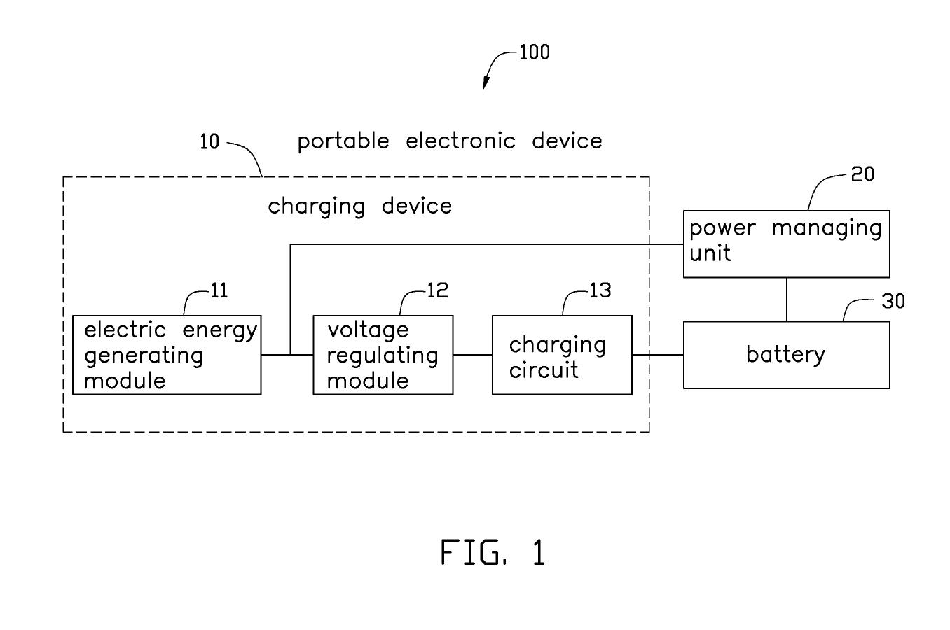

Referring to FIG. 1, an exemplary embodiment of a portable electronic device 100, such as a mobile phone or a personal digital assistant (PDA), includes a charging device 10, a power managing unit 20, and a battery 30. The charging device 10 is electrically connected to the battery 30. The power managing unit 20 are electrically connected to the charging device 10 and the battery 30.

The charging device 10 is installed in the portable electronic device 100 to sense the movement of the portable electronic device 100, and converts the kinetic energy resulting from movement if the portable electronic device 100 into electrical energy to recharge the battery 30. The charging device 10 includes an electric energy generating module 11, a voltage regulating module 12, and a charging circuit 13 electrically connected in series. The electric energy generating module 11 may be an acceleration transducer. The electric energy generating module 11 senses the movement of the portable electronic device 100, and converts the kinetic energy of portable electronic device 100 into electric energy, and then outputs a voltage to the voltage regulating module 12. The converted energy by the electric energy generating module 11 may be too unstable to directly charge the battery 30. The voltage regulating module 12 may be an existing driver integrated circuit (IC) and used to stabilize the unstable voltage to a stable voltage suitable for recharging the battery 30. The charging circuit 13 is used to output the stabilized voltage from the voltage regulating module 12 to the battery 30.

The power managing unit 20 is electronically connected to the electric energy generating module 11 and the battery 30. The power managing unit 20 detects the electric energy converted by the electric energy generating module 11 and the power stored by the battery 30, and controls the electric energy generating module 11 to recharge the battery 30.

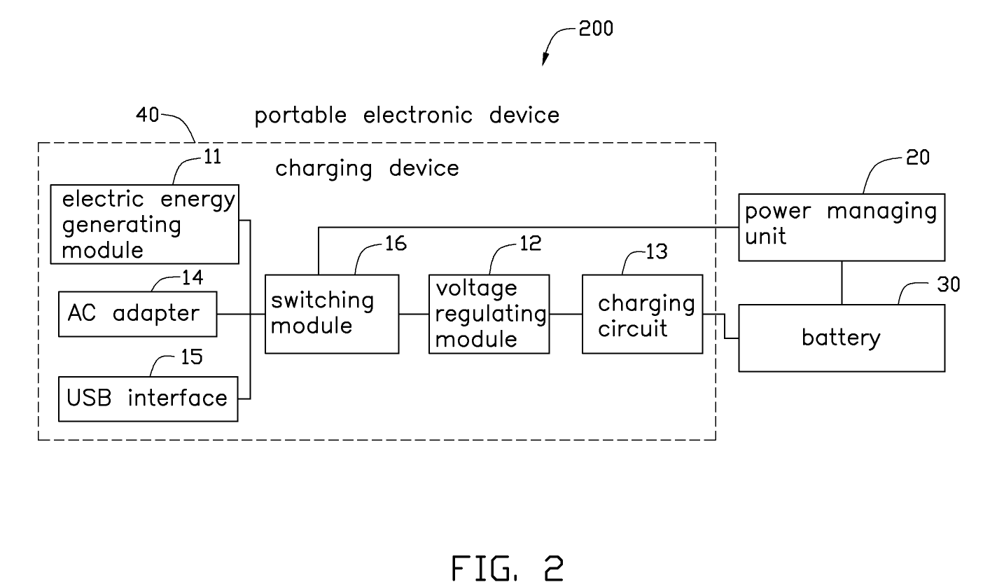

Referring to FIG. 2, another exemplary embodiment of the charging device 40 is similar to the charging device 10 and further includes an alternating current (AC) adapter 14, a universal serial bus (USB) interface 15, and a switching module 16. One end of the switching module 16 is electrically connected to the AC adapter 14, the USB interface 15 and the electric energy generating module 11, another end of the switching module 16 is connected to the voltage regulating module 12. The AC adapter 14 is used to connect to a power supply to recharge the battery 30. The USB interface 15 is used to connect to another electronic device such as a computer to recharge the battery 30 via a cable. The switching module 16 can switch among the electric energy generating module 11, the AC adapter 14, and the USB interface 15 to choose different recharging means.

When the charging device 40 is installed in a portable electronic device 200, the power managing unit 20 is electrically connected to the switching module 16. The power managing unit 20 controls the switching module 16 to choose the recharging means according to the electric energy converted by the electric energy generating module 11, and the connection state of the AC adapter 14 and the USB interface 15. For example, when the AC adapter 14 is not connected to a power supply, the USB interface 15 is not connected to other electronic device, the switching module 16 switches to the electric energy generating module 11 to recharge the battery 30. When the charging device 40 is static, and there is no electric energy converted by the electric energy generating module 11, the switching module 16 switches to the AC adapter 14 or the USB interface 15 to recharge the battery 30.

The charging device 40 have a common charging mode and a kinetic energy charging mode and can use kinetic energy and the existing power source to charge the battery 30. The charging device is convenient to operate and charge the battery, and the charging device can store and charge the battery when a user carries with the charging device on the move.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A charging device for recharging a battery, comprising:
an electric energy generating module used to convert kinetic energy into electric energy including an unstable voltage;
a voltage regulating module electrically connected to the electric energy generating module, and used to stabilize the unstable voltage into stable voltage; and
a charging circuit electrically connected to the voltage regulating module and a battery to output the stable voltage to the battery.

2. The charging device as claimed in claim 1, wherein the electric energy generating module is an acceleration transducer.

3. The charging device as claimed in claim 1, further comprising a AC adapter and a switching module, one end of the switching module is electrically connected to the AC adapter and the electric energy generating module, another end of the switching module is electrically connected to the voltage regulating module, the switching module can switch between the AC adapter and the electric energy generating module.

4. The charging device as claimed in claim 3, further comprising a USB interface electrically connected to the switching module, the switching module can switch among the AC adapter, the electric energy generating module, and the USB interface.

5. A portable electronic device, comprising:
a battery;
a charging device comprising
an electric energy generating module used to convert kinetic energy into electric energy having an unstable voltage;
a voltage regulating module electrically connected to the electric energy generating module, and used to stabilize the unstable voltage into stable voltage; and
a charging circuit electrically connected to the voltage regulating module and the battery to output the stable voltage to the battery; and
a power managing unit electrically connected to the electric energy generating module and the battery to control the electric energy generating module to recharge the battery.

6. The portable electronic device as claimed in claim 5, wherein the electric energy generating module is an acceleration transducer.

7. The portable electronic device as claimed in claim 5, wherein the charging device further includes a AC adapter and a switching module, one end of the switching module is connected to the AC adapter and the electric energy generating module, another end of the switching module is connected to the voltage regulating module, the power managing module is connected to the switching module, and controls the switching module to switch between the AC adapter and the electric energy generating module.

8. The portable electronic device as claimed in claim 7, further comprising a USB interface connected to the switching module, the switching module can switch among the AC adapter, the electric energy generating module, and the USB interface.
